(19) United States
(12) Patent Application Publication
(10) Pub. No.: US 2003/0115723 A1
(43) Pub. Date: Jun. 26, 2003

(54) Releasable cable grip

(76) Inventor: Alan B. Shuey, Monongahela, PA (US)

Correspondence Address: PAUL A. BECK & ASSOCIATES, SUITE 100, 1575 McFARLAND ROAD, PITTSBURGH, PA, 15216-1808, US

(21) Appl. No.: 10/029,087

(22) Filed: Dec. 20, 2001

(51) Int. Cl. F16G 11/00

(52) U.S. Cl. 24/136 R

(57) ABSTRACT

A releasable cable grip for locking a cable within a housing is provided. Levers which extend through slots in the housing are fixed to spring biased wedges that force the cables within the cable grip against bores within the housing to lock the cables relative to the housing. By moving the levers outside the housing against the force of the springs biasing the wedges, the cables may be released relative to the housing.

### BACKGROUND OF THE INVENTION

1. Field of the Invention

This invention relates generally to the field of cable grips that provide a housing that grips a cable in order to fix the cable in a desired location. More particularly, the cable grip of the present invention is releasable through levers that are fixed to wedges that grip and may release the cable without any special tools.

2. Prior Art

Cable grips are known in the prior art. Cable grips have been utilized on fencing materials, on various wires, and on metal woven cable in order to fix the position of a housing on the cable and thereby prevent the cable from slipping relative to the housing. Cable grips are not new. In 1931 C. W. Kemper et al. were issued U.S. Pat. No. 1,811,942 for a cable grip. Facey et al. were issued U.S. Pat. No. 5,147,145 on Sep. 15, 1992 for Connector for Wires. A more recent example of a cable grip issued to Facey et al. on May 9, 2000, U.S. Pat. No. 6,058,574, which requires a special tool to release the cable grip when desired. The present invention requires no special tools to release the cable grip when desired.

### BRIEF SUMMARY OF THE INVENTION

A releasable cable grip for locking a cable within a housing is provided. The housing has a bore through it to receive the cable. A wedge is positioned within the housing and is spring loaded to bias the wedge against the cable within the bore to wedge the cable against the bore and thereby grip the cable. A release lever is fixed to the wedge and extends through a slot in the housing whereby the lever may be utilized to move the wedge away from the cable to release the cable and permit movement of the cable relative to the bore of the housing.

A releasable cable grip connector for locking a cable segment within a housing and for having a second cable segment pass through the housing is also provided. A housing having a first bore through it receives a first cable segment and a second bore through the housing parallel to the first bore receives a second cable segment. A channel within the body disposed to one side of the first bore and acutely inclined to it, at its inner end, breaks into the first bore. A wedge is positioned within the housing in the channel and is spring loaded to bias the wedge against the cable segment within the first bore to wedge the cable segment against the first bore and thereby grip the cable segment. A slot in the housing extends parallel to the channel and communicates with the channel. A release lever fixed to the wedge extends through the slot to the outside of the housing whereby the release lever may be utilized to move the wedge away from the cable segment and permit movement of the cable segment relative to the first bore.

Accordingly, it is an object of the present invention to provide a releasable cable grip that permits the cable to be released without any special tooling.

Another object of the present invention is to provide a releasable cable grip which may have multiple passages for cable segments.

Another object of the present invention is to provide a releasable cable grip with levers extending to the outside of the housing to permit release of the cable relative to the housing of the cable grip.

These and other objects of the present invention will become readily apparent as this description proceeds in conjunction with the accompanying drawings.

### BRIEF DESCRIPTION OF THE DRAWINGS

FIG. 1 is a perspective view of the housing of a releasable cable grip of the present invention.

FIG. 2 is a longitudinal sectional view of the housing of FIG. 1.

FIG. 3 is a sectional view similar to FIG. 2 showing the wedge and spring in place within the housing.

FIG. 4 is a sectional view similar to FIGS. 2 and 3 showing a cable through the cable grip being gripped by the wedge.

FIG. 5 is a sectional view of another embodiment of the present invention showing a cable grip with two cable securing bores.

FIG. 6 is a sectional view of another embodiment of the present invention showing a cable grip with two securing bores and having the wedges being urged to the external walls of the cable grip housing.

FIG. 7 is a perspective view of the housing of another embodiment of the present invention.

FIG. 8 is a longitudinal section of the cable grip of FIG. 7 showing the wedges and springs that are internal to the cable grip.

### DETAILED DESCRIPTION OF THE PREFERRED EMBODIMENTS

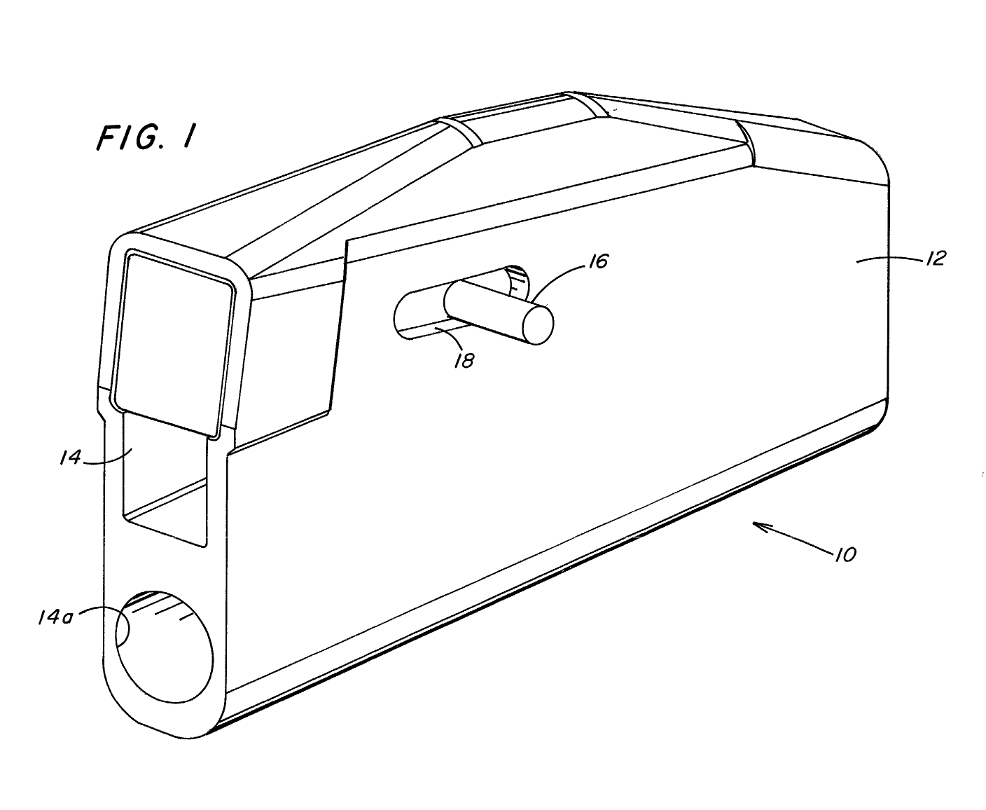

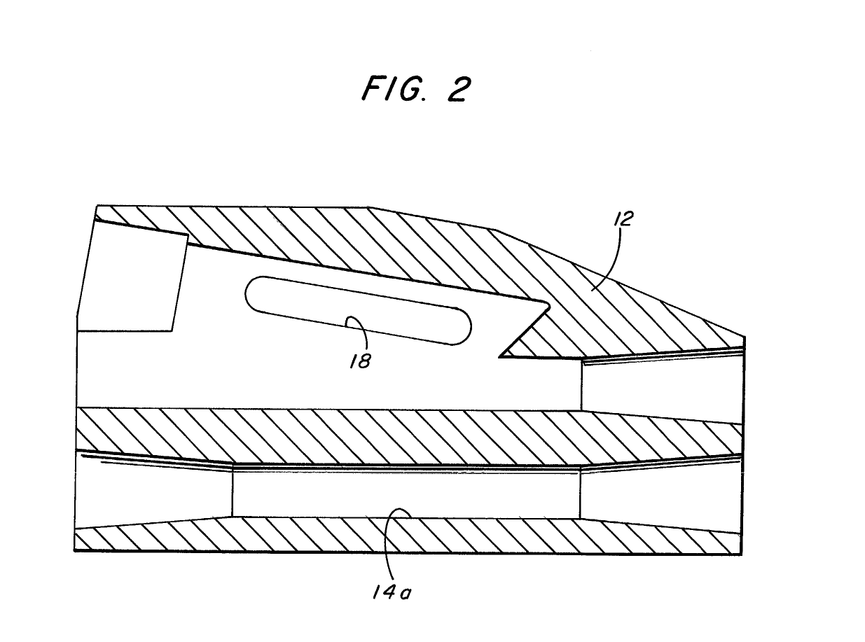

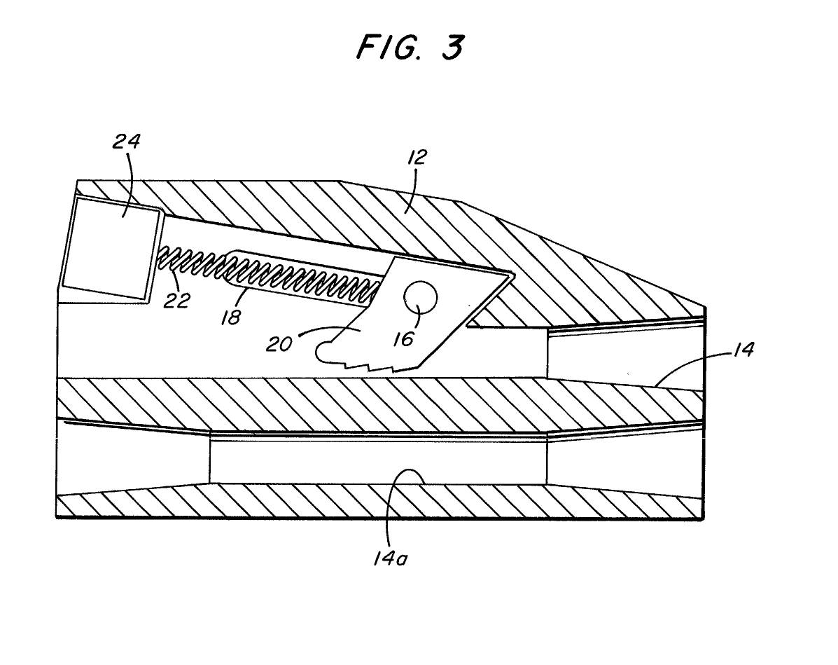

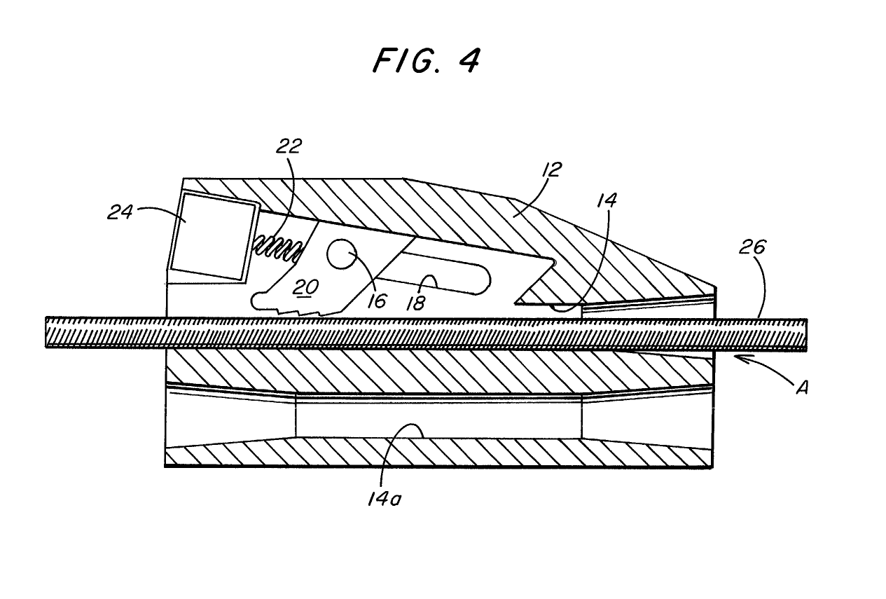

Referring to FIGS. 1-4 there is indicated generally at 10 a cable grip that has a housing 12 with cable receiving bores 14 and 14a. Release levers 16 protrude through slots 18 in the housing 12 and extend from each side of wedge 20 to which they are fixed. Spring 22 urges wedge 20 away from spring block 24 that is fixed to housing 12. As shown in FIG. 4, a cable 26 is inserted into the bore 14 in the direction of arrow A forcing the wedge 20 against the force of spring 22 while the wedge 20 remains in contact with cable 26. Any effort withdraw the cable 26 in the direction opposite from which it was inserted will result in the wedge 20 bearing against the cable and forcing the cable against the bore 14 of the housing 12. In the present embodiment, bore 14a is a free bore for receiving a cable that is not restrained within the cable housing. In other embodiments to be described, the second bore also has a cable restraining means. To release cable 26 as shown in FIG. 4, the levers 16 that extend from wedge 20 through slots 18 on either side of the housing 12 are moved against the spring force 22 to move the wedge 20 away from cable 26. Cable 26 may then be released and adjusted relative to the housing 12 without the use of any special tools or devices to release it.

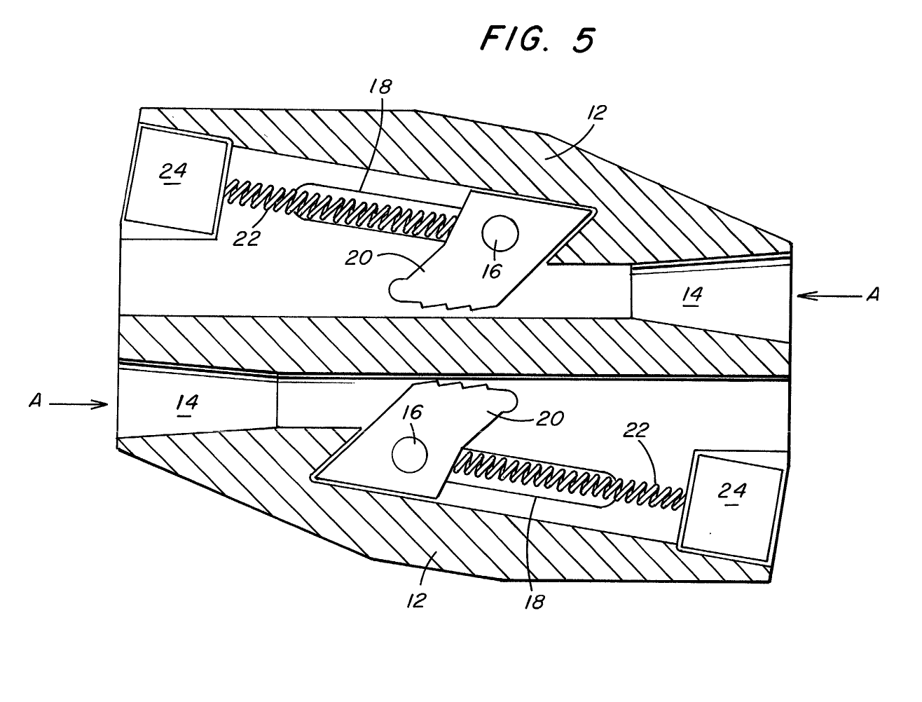

FIG. 5 shows a second embodiment of the present invention that has housing 12 with cable receiving bores 14 and wedges 20 with release levers 16 protruding from the wedges 20 through respective slots 18 in each side of the housing 12. The springs 22 urge the wedges 20 against cables (not shown) that are inserted in the direction of arrows A into each bore 14. In FIG. 5, as in the embodiment of FIGS. 1-4, springs 22 urge the wedges 20 parallel to passages or channels that are acutely inclined to the cable receiving bore 14.

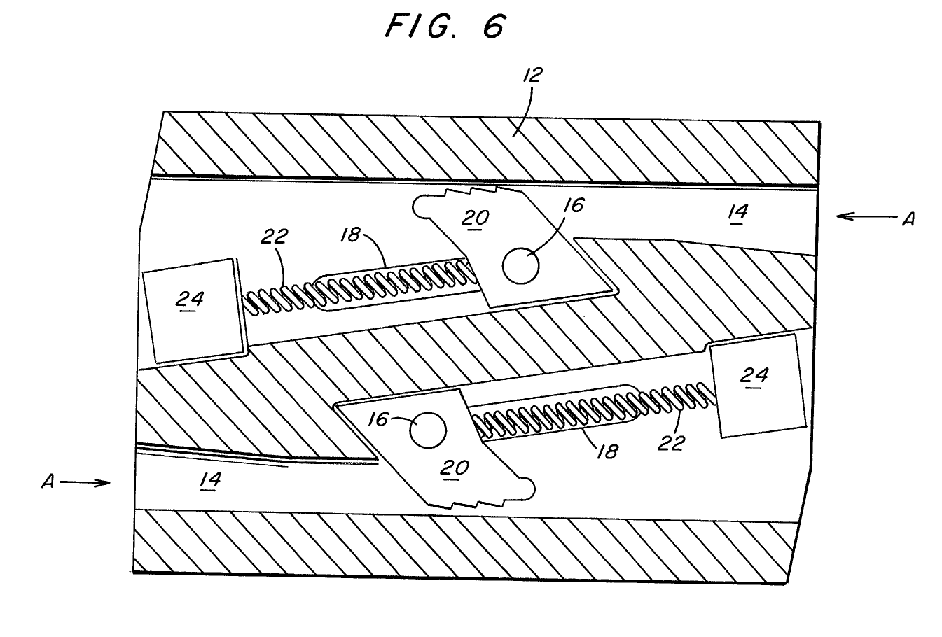

A third embodiment of the invention is shown in FIG. 6 in which the wedges 20 are located centrally of the housing 12 and when cables are inserted in the cable receiving bores 14, springs 22 force cables (not shown) outwardly against the outer walls of housing 12 as viewed in FIG. 6. Levers 16 that extend from each side of wedges 20 and through slots 18 on each side of housing 12 permit release of cables when the levers 16 are moved against the force of springs 22.

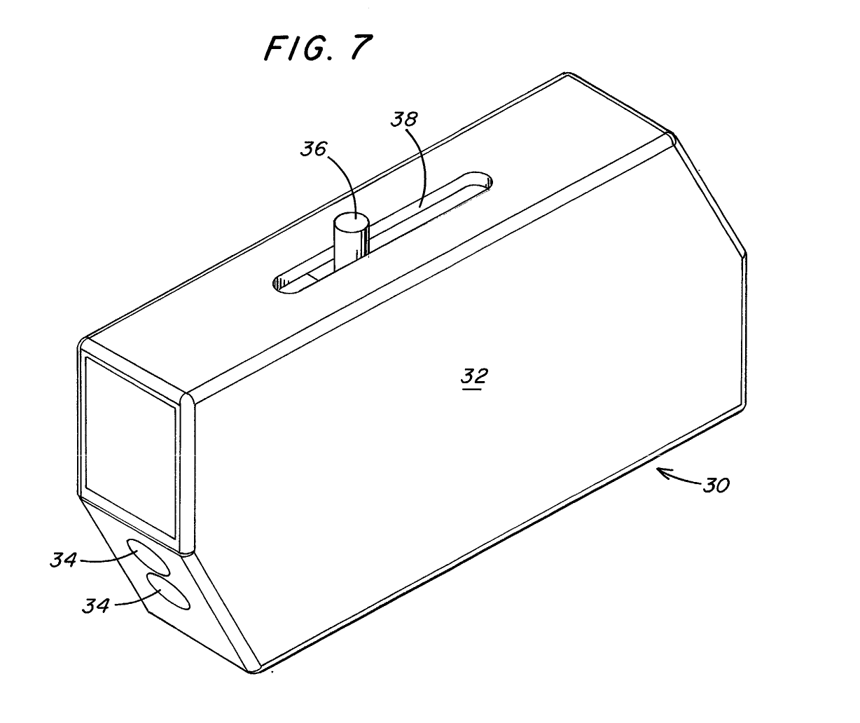

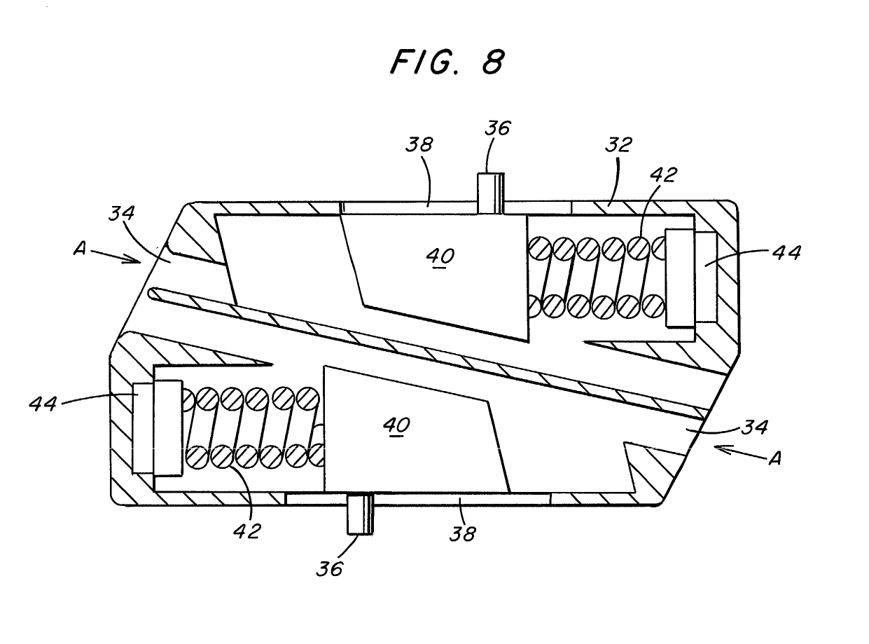

FIGS. 7 and 8 show a fourth embodiment of the present invention indicated generally at 30. Housing 32 has receiving bores 34. Both of the bores 34 are capable of gripping cables that extend through the bores 34. In this embodiment, release levers 36 extend through slots in the top and bottom of the housing 32 and are fixed to wedges 40. Springs 42 abut against spring block 44 and urge the wedges 40 away from spring blocks 44. Spring blocks 44 are fixed to housing 32. When it is desired to release cables that extend through cable receiving bores 34, respective levers 36 are utilized to move the wedges against the urging of springs 42 in order to free the cables (not shown).

In accordance with the provisions of the patent statutes, I have described the principle, mode of operation, and the preferred embodiments of my invention. It should be understood that the invention may be practiced otherwise than as specifically illustrated and described herein in accordance with the claims affixed hereto.

I claim:

1. A releasable cable grip for locking a cable within a housing comprising:
a housing having a bore therethrough to receive said cable;
wedge means positioned within said housing and spring-loaded to bias said wedge means against said cable within said bore to wedge said cable against said bore and thereby grip said cable;
a release lever fixed to said wedge means and extending through a slot in said housing whereby said lever may be utilized to move said wedge means away from said cable to release said cable and permit movement of said cable relative to said bore.

2. The releasable cable grip of claim 1 wherein said wedge means has a release lever extending outwardly from each side of said wedge means through respective slots in opposite sides of said housing.

3. The releasable cable grip of claim 1 wherein said housing has two bores to receive cable segments but only one of said bores has said wedge means and said release lever extending through a slot in said housing.

4. The releasable cable grip of claim 1 wherein said housing has two bores to receive cable segments and each of said bores has said wedge means and said release lever extending through slots in said housing.

5. The releasable cable grip of claim 4 wherein each of said wedge means has a release lever extending outwardly from each side of said wedge means through respective slots in opposite sides of said housing.

6. The releasable cable grip of claim 4 wherein wherein said wedge means are positioned in the central portion of said housing and are spring biased away from each other to force said cable segments outwardly away from each other.

7. The releasable cable grip of claim 6 wherein each of said wedge means has a release lever extending outwardly from each side of said wedge means through respective slots in opposite sides of said housing.

8. In a releasable cable grip connector for a cable comprising:
a body having through passage means adapted to receive a pair of oppositely directed cable end segments;
a channel within said body disposed to one side of one of said through passage means and acutely inclined to and, at its inner end, breaking into said through passage means;
wedge means within said channel adapted upon attempted withdrawal of said cable end segment from said through passage means to urge said cable end segment forcibly against said through passage means and thus secure said cable end segment firmly in said releasable cable grip connector;
the improvement comprising:
a slot in said body extending parallel to said channel and communicating with said channel;
a release lever fixed to said wedge means and extending through said slot to the outside of said body whereby said release lever may be utilized to move said wedge means away from said cable end segment to release said cable end segment and permit movement of said cable end segment relative to said through passage means.

9. The releasable cable grip connector of claim 8 wherein said wedge means has a release lever extending outwardly on each side of said wedge means through respective slots in opposite sides of said body.

10. The releasable cable grip connector of claim 8 wherein said body has two channels, one of said channels breaking into each through passage means with a wedge means in each of said channels and each of said wedge means having a release lever extending through a slot in said body.

11. The releasable cable grip connector of claim 10 wherein each of said wedge means has a release lever extending outwardly from each side of said wedge means through respective slots in opposite sides of said body.

12. The releasable cable grip connector of claim 10 wherein said channels and said wedge means are positioned in the central portion of said body and said wedge means force said cable end segments outwardly away from each other.

13. The releasable cable grip connector of claim 12 wherein each of said wedge means has a release lever extending outwardly from each side of said wedge means through respective slots in opposite sides of said body.

14. A releasable cable grip connector for locking a cable segment within a housing comprising:
a housing having a first bore therethrough to receive a first cable segment and a second bore therethrough parallel to said first bore to receive a second cable segment;
a channel within said body disposed to one side of said first bore and acutely inclined to and, at its inner end, breaking into said first bore;
wedge means positioned within said housing in said channel and spring loaded to bias said wedge means against said cable segment within said first bore to wedge said cable segment against said first bore and thereby grip said cable segment;
a slot in said housing extending parallel to said channel and communicating with said channel;
a release lever fixed to said wedge means and extending through said slot to the outside of said housing whereby said release lever may be utilized to move said wedge means away from said cable segment and permit movement of said cable segment relative to said first bore.

15. The releasable cable grip connector of claim 14 wherein said wedge means has a release lever extending outwardly on each side of said wedge means through respective slots on opposite sides of said housing.

16. The releasable cable grip connector of claim 14 wherein said housing has a second channel disposed to one side of said second bore and acutely inclined to and, at its inner end, breaking into said second bore with a second wedge means having a release lever extending through a second slot in said housing parallel to said second channel and communicating therewith.

17. The releasable cable grip connector of claim 16 wherein said wedge means and said second wedge means each has a release lever extending outwardly from each side of said wedge means and said second wedge means through respective slots in said housing parallel to said channel and said second channel.

18. The releasable cable grip connector of claim 16 wherein said channel and said second channel and said wedge means and said second wedge means are all positioned in the central portion of said housing and said wedge means and second wedge means force said cable segments outwardly away from each other.
